(19) United States
(12) Patent Application Publication
(10) Pub. No.: US 2026/0001062 A1
(43) Pub. Date: Jan. 1, 2026

(54) MATERIALS AND SYSTEMS FOR DEGRADING CHEMICAL CONTAMINANTS IN WATER

(71) Applicant: William Marsh Rice University, Houston, TX (US)

(72) Inventors: Michael S. Wong, Houston, TX (US); Bo Wang, Houston, TX (US); Kimberly N. Heck, Sugar Land, TX (US)

(73) Assignee: William Marsh Rice University, Houston, TX (US)

(21) Appl. No.: 18/881,224

(22) PCT Filed: Jul. 6, 2023
(86) PCT No.: PCT/US2023/027047

§ 371 Date: Jan. 3, 2025

Related U.S. Application Data
(60) Provisional application No. 63/367,762, filed on Jul. 6, 2022.

(51) Int. Cl. B01J 27/24; B01J 21/04; B01J 21/12; B01J 23/30; B01J 35/39; C02F 1/32; C02F 1/72; C02F 101/36

(52) U.S. Cl. CPC B01J 27/24; B01J 21/04; B01J 21/12; B01J 23/30; B01J 35/39; C02F 1/325; C02F 1/725; C02F 2101/36; C02F 2305/10

(57) ABSTRACT

A photocatalyst for degrading a one or more contaminants includes a photocatalytic core comprising boron nitride; and a layer coated on the core and comprising a non-semiconductor material; where the photocatalyst is catalytically active for degrading contaminants under conditions of irradiation by light; and where the layer improves a property of the photocatalyst as compared to the photocatalytic core in the absence of the layer.

### STATEMENT REGARDING FEDERALLY SPONSORED RESEARCH

This invention was made with government support under grant number EEC-1449500 awarded by the National Science Foundation. The government has certain rights in the invention.

### BACKGROUND

Water can contain various chemical contaminants. For example, the persistence, prevalence, and toxicity of perfluorinated compounds in the aqueous environment make them recalcitrant contaminants of emerging concern. Photocatalysis has shown potential for degrading perfluorinated compounds in water with air as an oxidant and light as the energy source. Commercial hexagonal boron nitride (“BN”) powder can efficiently photodegrade perfluorocarboxylic acids under ultraviolet C (“UV-C”) illumination. However, commercial boron nitride tends to degrade perfluorocarboxylic acids extremely rapidly without the use of energy intensive (high wattage) processes. Therefore, there remains a need for improved materials and systems for degrading chemical contaminants in water.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a photocatalyst, including a photocatalytic core comprising boron nitride; and a layer coated on the core and comprising a non-semiconductor material; where the photocatalyst is catalytically active for degrading contaminants under conditions of irradiation by light; and where the layer improves a property of the photocatalyst as compared to the photocatalytic core in the absence of the layer.

In another aspect, embodiments disclosed herein relate to a membrane for use in a water purification system, the membrane comprising a polymer and a photocatalyst contained within the polymer. As described above, the photocatalyst may include a photocatalytic core comprising boron nitride; and a layer coated on the core and comprising a non-semiconductor material; where the photocatalyst is catalytically active for degrading contaminants under conditions of irradiation by light; and where the layer improves a property of the photocatalyst as compared to the photocatalytic core in the absence of the layer.

In another aspect, embodiments disclosed herein relate to a system for degrading one or more contaminants that include fluorinated compounds and other wastewater contaminants, where the system includes a reactor for receiving an aqueous liquid comprising at least one contaminant, where the reactor contains a photocatalyst. As described above, the photocatalyst may include a photocatalytic core comprising boron nitride; and a layer coated on the core and comprising a non-semiconductor material; where the photocatalyst is catalytically active for degrading contaminants under conditions of irradiation by light; and where the layer improves a property of the photocatalyst as compared to the photocatalytic core in the absence of the layer. The system may further include a light source for directing the irradiating light to the photocatalyst; and an oxidant source in fluid communication with the reactor.

In another aspect, embodiments disclosed here relate to a method for degrading contaminants that includes introducing an aqueous liquid comprising at least one contaminant to a reactor, where the reactor contains a photocatalyst. As described above, the photocatalyst may include a photocatalytic core comprising boron nitride; and a layer coated on the core and comprising a non-semiconductor material; where the photocatalyst is catalytically active for degrading contaminants under conditions of irradiation by light; and where the layer improves a property of the photocatalyst as compared to the photocatalytic core in the absence of the layer. The method may further include introducing an oxidant to the reactor; activating the photocatalyst by directing the irradiating light from a light source to the photocatalyst to form an activated photocatalyst; and contacting the oxidant and the at least one contaminant with the activated photocatalyst to react the oxidant and the at least one contaminant, thereby degrading the at least one contaminant.

Other aspects and advantages of the claimed subject matter will be apparent from the following description and the appended claims.

### BRIEF DESCRIPTION OF DRAWINGS

FIG. 1 illustrates a slurry reactor system according to embodiments herein.

FIG. 2 illustrates a fiber optic reactor system according to embodiments herein.

FIG. 3 is an exemplary graph, for different amounts of SiO₂ coated on BN, of the pH of dispersion, according to one or more embodiments.

FIGS. 4A, 4B, 4C are exemplary graphs for different amounts of SiO₂ coated on BN, of (a) PFOA concentration-time profiles (b) corresponding calculated initial reaction rates and (c) Fluoride concentration-time profile, respectively, according to one or more embodiments.

FIGS. 5A, 5B, 5C are exemplary graphs, for different amounts of SiO₂ coated on BN, of (a) PFOA concentration-time profiles, (b) fluoride ion concentration profiles, and (c) pH profiles in dark, respectively, according to one or more embodiments.

FIGS. 6A, 6B are exemplary graphs, for DI control, no catalyst (vacuum ultraviolet (“VUV”) only), and a SiO₂ coated BN, of (a) PFOA concentration-time profiles, (b) fluoride ion concentration profiles, respectively, according to one or more embodiments.

FIGS. 7A, 7B, 7C are exemplary graphs, for different amounts of Al₂O₃ coated on BN, of (a) PFOA concentration-time profiles, (b) initial reaction rate profiles, and (c) fluoride ion concentration profiles, respectively, according to one or more embodiments.

FIGS. 8A, 8B, 8C are exemplary graphs, for different amounts of ZrO₃ coated on BN, of (a) PFOA concentration-time profiles, (b) initial reaction rate profiles, and (c) fluoride ion concentration profiles, respectively, according to one or more embodiments.

FIG. 9 shows an exemplary graph of PFOA concentration-time profiles in DI water (filled marks) and in 6000 ppm-NaCl water (open marks) for a BN/TiO₂ composite (squares), a specially silica-coated BN material (hexagons), and TiO₂ (circles), according to one or more embodiments.

FIGS. 10A, 10B, and 10C show exemplary graphs of PFOA concentration-time profiles illustrating effects of common salt co-solutes, pH, and organic matter, respectively, on photocatalytic degradation of PFOA for the specially silica-coated BN material, according to one or more embodiments.

### DETAILED DESCRIPTION

In one aspect, embodiments disclosed herein relate to a material to degrade one or more contaminants. The contaminants can include persistent organohalogen compounds, in water. The material is photocatalytic. The material includes a boron nitride (“BN”) photocatalyst optionally combined with a smaller band gap semiconductor photocatalyst, which is activated with light ranging from 160-700 nm. The present inventors developed a way to improve the stability of the BN alone or the composite material by coating with a non-semiconductor layer which represents a new composition of matter.

Embodiments disclosed herein are directed to a photocatalytic system that may degrade chemicals, such as pollutants typically found in drinking water or municipal and industrial wastewaters, thereby detoxifying the chemicals.

Embodiments disclosed herein may provide a broad set of stakeholders (e.g., industrial organizations, governmental organizations, and citizens) a secure source of clean water. Embodiments disclosed herein may broaden access to clean drinking water by cleaning water from a variety of potential sources (e.g., groundwater from wells, saltwater, brackish water, or recycled industrial water). Some embodiments of the present disclosure may be modular systems that offer compact embodiments of catalytic treatment systems. These modular systems may provide drinking water from the scale of a household, to a neighborhood, or to a remote town. In addition, these modular embodiments may also provide access to clean water in the event of a natural disaster.

In addition to drinking water, embodiments herein may improve the impact of oil and gas exploration and production operations on water supplies by helping to increase the quality of water cleanup for reuse and recycle. The environmental impact of water use in these industrial settings will be improved, saving energy and water resources.

Embodiments herein may relate to the design and manufacture of multifunctional nanomaterials to adsorb a wide variety of pollutants, including: oxo-anions, total dissolved solids, nitrates, salts, organics, foulants, scalants, viruses and microbes, among others. These nanomaterials may be immobilized in membranes that are packaged into system modules. The use of modules offers flexibility of targeted pollutant(s) and end-use application capacity or scale of delivered water rate. Novel photonic, catalytic, and/or photocatalytic engineered nanomaterials (ENMs) described herein may introduce new approaches to transform water treatment from a large, chemical- and energy-intensive process toward compact physical and catalytic systems. These innovations may benefit multiple stakeholders, from rural communities and locations hit by natural disasters to hydraulic fracturing oil and gas sites, where reuse of produced waters minimizes regional environmental impacts.

Contaminants enter the water system from a number of sources, such as industrial discharges, surface run-off in stormwater, agricultural runoff, infiltration of fire-fighting foams or other pollutants into groundwater, and discharge of both untreated and treated sewage from cities. Perfluorocarboxylic acids (PFOA), part of the Per/polyfluorocarboxylic substances (PFAS) family, is an example of a particularly harmful contaminant found in the water supply. PFAS have been detected in water due to their application as surfactants, additives, firefighting foams, and lubricants. Toxicological studies indicated that PFASs bioaccumulate in humans and wildlife, potentially leading to developmental and reproductive problems, liver damage, and cancer. Concern over water contamination by harmful contaminants, such as PFOA, highlights the need for effective treatment approaches provided by embodiments of the present disclosure. In addition to PFOA, PFAS may also include perfluorooctanesulfonic acid (PFOS), F-53B, ADONA, FOSA, El, Hydro-EVE acid, PFMOAA, 5:3 FTCA, PFBS, HFPO-TA, 8:2 FTSA, Sulfluramid, 6:2 FTOH, GenX, 6:2 FTAB, 6:2 FTCA, 6:2 FTSA, 8:2 FOH, HFPO-DA, Nafion by-product 2, PFBA, PFHxA, PFHxS, PFNA, PFO2HxA, PFO3OA, PFO4DA, PFO5DoDA, PFPrA.

Generally, contaminants are degraded in aqueous liquids to detoxify pollutants that may otherwise cause harm on the environment. Wastewater is a representative example of an aqueous liquid that requires degradation of contaminants to protect the environment and drinking water sources. Removing perfluorinated compounds, such as PFOA, is particularly challenging in the treatment and detoxification of wastewater. The challenge emerges because of very strong carbon-fluorine bonds and the surfactant chemical nature of per- and polyfluorinated compounds. Conventional PFOA degradation methods include advanced oxidation processes (AOPs). Ultraviolet-based AOPs promote direct and indirect photochemical reactions that show potential for efficient degradation of PFOA. Vacuum ultraviolet (VUV) and UV-C irradiation with high spectral irradiance decompose PFOA via photolysis. However, defluorination of PFOA is slow, making direct photolysis of PFOA unfeasible as an effective water treatment method. VUV and UV-C irradiation in solutions containing sulfite or persulfate also degrades PFAS, but continuous chemical addition is required.

Photocatalytic degradation of contaminants in aqueous liquids presents advantages over other methods. Advantages of photocatalysis include using ambient conditions for reaction, air as the oxidant, and light as the energy source. Photocatalysis also directly destroys targeted contaminants, thus rendering the contaminant non-toxic without additional processing. For example, physical separation methods often produce waste streams and may require regenerative treatments to destroy the separated contaminants.

Conventional photocatalyst systems may be operated in recirculating slurries that do not require continuous addition of reagent. PFOA degradation occurs through different reaction mechanisms, depending on the photocatalyst composition and reaction conditions. The conventional, commercially available photocatalyst is titanium dioxide (TiO₂). Although TiO₂ is used as a photocatalytic material, the rate of PFOA degradation is relatively slow and thus requires high-energy to degrade PFOA, which equates to a high operating cost for water treatment.

Boron Nitride (BN) is generally considered an electrical insulator, due to its wide band gap. The term “boron nitride” (BN) refers to a compound comprising boron and nitrogen and may also include modified BN. BN has also been investigated previously for its use in thermal (i.e., non-photo) catalysis. BN is also conventionally understood to act as a support material, wherein an active material (typically group 8b metals) is immobilized upon it. BN has also been proposed to treat organic compounds in water due to its high hydrophobicity and surface area. However, these methods only remove the organic compounds and do not detoxify them (i.e., further water treatment remains necessary).

According to one or more embodiments, a coated or uncoated BN-based material (for example, but not limited to powders, particles, and nanoparticles) is the active photocatalytic material. The coating can be silica or another non-semiconductor. The BN-based materials can be hexagonal BN, BN nanotube, or BN-containing composite with another semiconductor, including metal oxides (e.g. coated BN/TiO₂, coated and uncoated BN/ZrO₂, etc.), carbides (e.g. coated and uncoated BN/SiC, etc.), or nitrides (e.g. coated and uncoated BN/CₓN_{y} etc.). In the system, coated BN-based material can be present as a slurry or immobilized e.g. as part of a coating on particles or fibers. Light from a light source including vacuum ultraviolet light (“VUV”), ultraviolet (“UV”) light such as ultraviolet A (“UV-A”), ultraviolet B (“UV-B”), ultraviolet C (“UV-C”), visible light, ambient light, simulated sunlight, and natural sunlight, is used to disinfect or initiate a photocatalytic reaction of the material with the target compound. The presence of dissolved oxygen in the water promotes the hypothesized formation of reactive radical species, which are responsible for the degradation of the target contaminants.

According to one or more embodiments, a composite of boron nitride and metal oxide can be used as the photocatalytic core on which can be layered the present non-semiconductor material. In some embodiments, the photocatalyst may be a mixture obtained by mixing BN powder and metal oxide powder. In some embodiments, BN/metal oxide photocatalyst may be a mixture obtained by introducing BN powder and metal oxide powder into a liquid medium and mixing. In certain embodiments, BN/metal oxide photocatalyst may also be in a form of a composite material containing BN photocatalyst and metal oxide photocatalyst. The composite material comprising BN photocatalyst and metal oxide photocatalyst may be prepared in a variety of methods. The method may include mixing BN photocatalyst and metal oxide photocatalyst in a liquid medium which may include water and/or alcohol to produce a suspension, heating the suspension to remove the liquid medium and further heating to calcine the BN photocatalyst and metal oxide photocatalyst to obtain the composite material. In some embodiments, the BN/metal oxide photocatalyst may be a mixture of the BN powder and metal oxide powder and a composite material of the BN and metal oxide. A weight ratio of BN to metal oxide may be 1 to 20, 1 to 10, 1 to 5, 1 to 3, 1 to 1, 3 to 1, 5 to 1, 10 to 1 or 20 to 1. For example, a composite of boron nitride and TiO₂ that can be used as the photocatalytic core on which can be layered the present non-semiconductor material. A weight ratio of BN to TiO₂ may be 1 to 20, 1 to 10, 1 to 5, 1 to 3, 1 to 1, 3 to 1, 5 to 1, 10 to 1 or 20 to 1. When the BN-based material includes BN and TiO₂, it may further include one or more transition metals. The transition metals used with the BN—TiO₂ photocatalyst may include precious metals such as Pt, Pd, Rh, Ru, Ag and Au, or non-precious metals such as Cu and Ni. The transition metal may be introduced to the mixture of BN powder and TiO₂ powder or may be incorporated into the composite material comprising the BN photocatalyst and the TiO₂ photocatalyst. An amount of transition metals used with the BN—TiO₂ photocatalyst may be 0.001% or more, 0.01% or more, 0.1% or more, 0.2% or more, 0.5% or more or 1.0% or more.

According to one or more embodiments, the coating includes a non-semiconductor oxide layer, such as SiO₂, AlₓO_{y} or others. Although BN basal planar of BN is hydrophobic, oxygen-containing defect sites will make BN hydrolyze in water and release ammonia. The present inventors added various BN-based materials to perfluorocarboxylic acid (“PFOA”) containing acidic water, let the dispersion stir in the dark, and measured the pH of the aqueous solution as a proxy for basic ammonium release. The synthesis of non-semiconductor oxide layer coated BN-based material may follow known methods for coating the semiconductor oxide material on the BN-based material. For example, SiO₂ may be coated on BN by the Stöber sol-gel method. The weight loading of the semiconductor oxide layer on the BN-based material may range from 1 wt % non-semiconductor oxide to as high as 10 wt %. For example, the weight loading may be 1, 2, 3, 4, 5, 6, 7, 8, 9, or 10 wt %, or other non-integer values from 1 to 10 wt %.

Additionally, due to the ease of functionalizing SiO₂ and other metal oxides with silanes, polymers, and other compounds, the present inventors contemplate that further surface modifications of the surface BN can further increase activity toward PFAS or allow the photocatalyst to target other environmental contaminants. The addition of positively or negatively charged groups to the surface could encourage for the electrostatic attraction of negatively or positively charged contaminants to the surface of the BN, thereby accelerating interaction with photogenerated electrons, holes, and ROSs. Additionally, the overall hydrophobicity of the surface can be tuned to attract contaminants of interest and repel nontoxic co-occurring contaminants. Functional groups may also be added to selectively trap other organic contaminants; adding phenyl groups, for instance, may encourage the adsorption of phenyl-containing contaminants (e.g. BTEX, chlorobenzene, etc.) through π-π interactions, or adding cyclodextrins may also entrap other hydrophobic molecules.

Coating the BN-based material with an inorganic oxide can allow for the addition of other functional metals or metal oxides. Silica, for instance, is commercially a support for a number of transition metal catalysts. One manifestation can be the immobilization of catalytic metal nanoparticles (such as Ag, Au, Pd, Pt, Ir, Rh, Ru, etc.) to the surface to enhance specific pollutant adsorption or to act as photogenerated e⁻ sinks to reduce recombination events and improve activity. Other manifestation can be the inclusion of metal oxide nanodomains (such as Al_{y}Oₓ, WOₓ, etc.) which can act as Lewis or Bronsted acid sites, thus attracting Lewis or Bronsted basic molecules (e.g. 1,4-dioxane, NH₃, etc.) to the surface for enhanced degradation. Even though the incorporation of the latter tends to be done at high temperatures, the present inventors contemplate successful functionalization to be achieved since BN is extremely thermally stable.

In one or more embodiments, a concentration of photocatalyst in a form of a composite material or in a form of a mixture in treated wastewater in a slurry mixture may be in a range from 0.1 g/L or more and 5.0 g/L or less. The photocatalyst may be in a form of a composite material or in a form of a mixture may be coated to a thicknesses in a range having a lower limit selected from any one of 0.01 um, 0.025 um, 0.05 um, 0.075 um, 0.1 um, 0.25 um, 0.5 μm, 0.75 μm and 1 um to an upper limit of 5 mm, 6 mm, 7 mm, 8 mm, 9 mm and 10 mm where any lower limit may be combined with any upper limit, on fixed surfaces such as sand, glass, steel or others.

In one or more embodiments of the present disclosure, the present photocatalyst may be active for degrading contaminants, such as PFOA, in an aqueous solution without the use of additional chemicals. It has been found that the present photocatalyst is active for the heterogeneous photodegradation of PFOA and may be as much as four times more effective than conventional photocatalysts, such as TiO₂. In addition to degradation of stable and recalcitrant compounds like PFOA, embodiments of the present disclosure may also be used for the degradation of less-stable compounds, such as 1,4-dioxane, pharmaceuticals, pesticides, and chlorinated solvents. Embodiments of the present disclosure may also be used for the degradation of aromatic compounds such as phenol.

In another aspect, embodiments disclosed herein relate to a membrane to degrade one or more contaminants. The membrane can include a polymer and the photocatalyst.

In another aspect, embodiments disclosed herein relate to a system to degrade contaminants. The system mineralizes the contaminants to non-toxic products, thereby cleaning the water of the contaminants. In some embodiments, the system for degrading contaminants may include a reactor containing the photocatalyst, where the reactor is configured for receiving an aqueous liquid comprising at least one contaminant, where the photocatalyst is capable of degrading the contaminants for at least one treatment cycle.

It will be understood that while the non-semiconductor material may be coated on the BN-based material to form the photocatalyst, the photocatalyst itself may in turn be coated on a support present in the reactor, such as a particle or a fixed-geometry surface. Regardless of the manner in which the present photocatalyst is disposed in a reactor, the photocatalyst may be disposed largely on the external surface of a particulate support material or fixed geometry surfaces in a manner providing a large surface area and efficient exposure of the photocatalyst to light.

In embodiments of the present disclosure, the photocatalyst may be affixed to a surface of particles, such as particulate support materials, and that may be used in a slurry reactor or fixed bed reactor, for example. The photocatalyst may be applied to, deposited upon, or otherwise associated with suitable particulate support materials by various methods understood by those skilled in the art. In the present disclosure, the term “support materials” refers to the “particulate support materials” and may be used interchangeably. Such particles may be referred to as “photocatalyst particles”. Particulate support materials may include, among other compounds, silica, alumina, titania, activated carbon, polymers, and mixtures of these particulate support materials, therein. The size of the particulate support materials may be in a range from 10 nm to 10 mm, for example, depending upon the reactor type (fixed bed or slurry). As a photocatalyst, the particulate support materials are preferably low surface area support materials, and the photocatalyst may be disposed largely on an exterior or exposed portion of the particle such that the photocatalyst may be exposed to light during use. When used in a slurry bed reactor, particulate support materials of sufficient strength should be used, such that contact with other photocatalyst particles does not result in damage to the photocatalyst that may render the photocatalyst unsuitable for the intended reaction.

In one or more embodiments of the present disclosure, the photocatalyst may be present on fixed-geometry surfaces. Herein, fixed-geometry surfaces may include immobilized surfaces, walls of the reactor, the exterior surface of the light source, optical fiber structures, polymer rods, fixed bed membranes, and other suitable surfaces. These surfaces may be immobilized within a system and configured to allow a flow of a fluid across the outside surface area of the fixed-geometry surface. The photocatalyst may be applied to the outside surface area of the fixed-geometry surface by coating methods understood by those skilled in the art. In certain embodiments, the fixed-geometry surface is the light source configured to conduct light waves through the inside of the structure, thereby exposing and activating the present photocatalyst.

One example of a reactor that may be used in certain embodiments is a slurry reactor. In some embodiments, the reactor may be a batch reactor, a semi-batch reactor or a continuous flow reactor. A photocatalytic slurry reactor may be configured for batch, semi-batch or continuous flow processing. The photocatalyst may be disposed in the slurry reactor with an aqueous liquid, such as wastewater. The slurry reactor may be configured with a light source, such as an ultraviolet lamp, which may be disposed internal or external to the reactor. The slurry reactor may also be configured for fluid communication with an oxidant source, such as a flow line to the reactor, an open surface of the reactor to the ambient air where agitation or other interaction with the ambient air may result in dissolution of oxygen within the aqueous liquid, or other suitable fluid that may result in oxygen being dissolved in the aqueous liquid upstream before introduction of the aqueous liquid into the reactor.

Embodiments of the present disclosure may also include reactors configured to hold a stationary photocatalyst, such as the photocatalyst disposed on fixed-geometry surfaces as described above. Photocatalytic reactors with fixed, or stationary catalysts may be operated with batch, semi-batch, and continuous flow processing. The fixed-geometry surface may be fitted to be disposed in the reactor, wherein an aqueous liquid, such as wastewater, may be in fluid communication with the photocatalyst disposed on the fixed-geometry surface. The reactor may be configured with a light source, such as ultraviolet lamps, visible light lamps and simulated sunlight lamps, which may be internal or external to the reactor. The reactor may be configured to expose the content to natural sunlight. The reactor may also be configured for fluid communication with an oxidant source, such as a flow line to the reactor, an open surface of the reactor to the ambient air where agitation or other interaction with the ambient air may result in dissolution of oxygen within the aqueous liquid, or other equivalent means that may result in oxygen being dissolved in the aqueous liquid upstream before introduction of the aqueous liquid into the reactor.

As shown in FIG. 1, embodiments disclosed herein may include a slurry reactor system 100. In the slurry reactor system 100, an oxidant is present in the slurry reactor 12. The oxidant source may come from a line (not shown) to supply the oxidant, such as oxygen. The slurry reactor 12 may also be open to the surrounding environment wherein ambient air may act as the oxidant. The wastewater 14 enters through line 11 into a slurry reactor 12. The wastewater 14 from line 11 mixes with fluidized media, herein photocatalyst coated particles 13, to create a slurry. The photocatalyst is coated on particles using methods understood by those skilled in the art. By pre-mixing photocatalyst nanopowders and the support materials with water, and then evaporating and calcining in the air atmosphere, photocatalyst might be coated on the support surface. The photocatalyst coating may also be polymer nano-composites wherein a paste is prepared by mixing photocatalyst nanopowders with a binder which may be an organic binder such as polyethylene glycol, or an inorganic binder such as zirconium oxide and silicone oxide, and may be condensed by evaporation. The paste may then be applied to a particle surface to create photocatalyst coated particles 13.

As shown in FIG. 1, wastewater 14 flows inside the slurry reactor 12 and passes over the photocatalyst coated particles 13. As the wastewater 14 and photocatalyst coated particles 13 move in the slurry reactor 12, light source 15 exposes the contents of the slurry reactor 12 to light waves, such as simulated sunlight and/or ultraviolet light. In embodiments herein, simulated sunlight or ultraviolet light (mono- or poly-chromatic) activate the photocatalyst on the photocatalyst coated particles 13. The photocatalyst particles 13 that have been activated then catalyze the reaction of the oxidant and contaminants, thereby degrading the water contaminants.

The time required for the photocatalytic treatment of the wastewater according to embodiments of the present disclosure may depend upon the concentration of contaminant, type of contaminant, type of photocatalyst application (i.e., photocatalyst coated on a fixed surface or present in a slurry), the photocatalyst loading, light exposure limitations, and other factors that may be readily understood by those skilled in the art with the benefit of the present disclosure. The treated wastewater 16, flows out of the slurry reactor 12 through line 17.

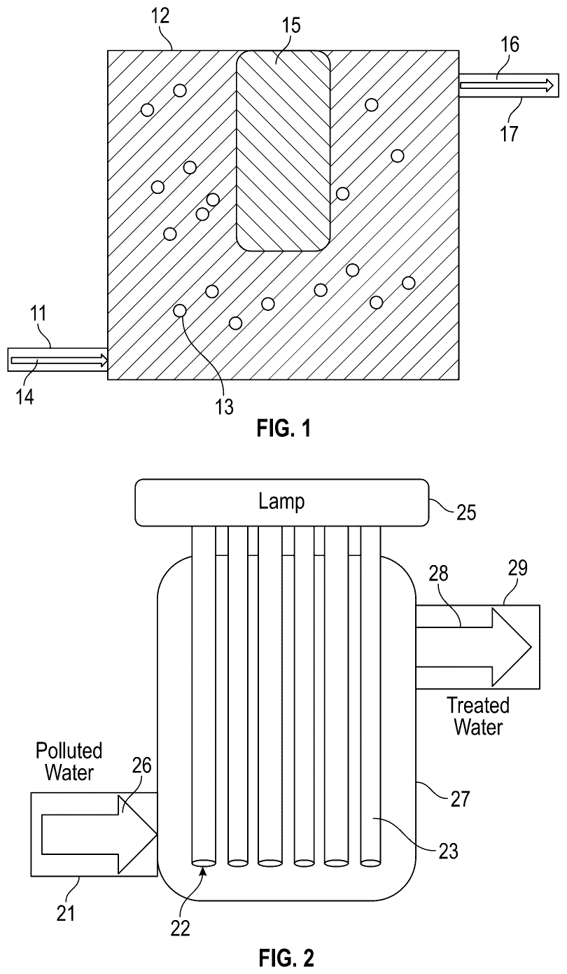

In embodiments of the present disclosure, a photocatalyst coating may be deposited and immobilized onto a fixed surface, such as glass, metal, membrane, or substrate. As shown in FIG. 2, fiber optic reactor system 200 depicts optical fiber rods 22 as a surface for the photocatalyst coating 23. The photocatalyst coating 23 may be applied directly to the surface configured to direct ultraviolet light or simulated sunlight from a light source 25 to the photocatalyst coating 23 in the presence of the wastewater 26. The wastewater 26 enters the fiber optic reactor system 200 through line 21 and into the fiber optic reactor 27. As in FIG. 1, fiber optic reactor 27 is configured to draw an oxidant from a source, such as the ambient air via an open reactor vessel. The wastewater 26 passes over the photocatalyst coating 23 in the presence of light waves, and an oxidant source. The light waves originate from a light source 25, such as a lamp. The photocatalyst coating 23 reacts with the light waves and oxidant to degrade the contaminants in the wastewater via pathways described herein. The treated wastewater 28 flows out of the fiber optic reactor 27 though line 29.

In some embodiments of the present disclosure, the reactor systems, such as the slurry reactor system 100 and fiber optic reactor system 200, may be operated in batch, semi-batch or in continuous flow modes. It is understood by those skilled in the art that the choice in modes may depend on a multitude of considerations, such as the location of the need for a reactor, the resources and tools available, and the immediacy of the need for clean water. For example, natural disasters require immediate action but may have limited resources and compromised logistics, thus batch or semi-batch modes may be a more convenient choice.

FIG. 1 and FIG. 2 show embodiments of single-phase reactor systems. It will be understood by those in the art that embodiments of the present disclosure may be 2-, 3-, or multiple-phase reactor systems.

In another aspect, embodiments disclosed herein relate to a method to degrade one or more contaminants. The composite material, coated BN, or coated composite is added as a slurry, a packed bed, or a coating in a reactor and a light source is used to initiate a photocatalytic reaction of the BN with the target compound. The presence of dissolved oxygen in the water promotes the hypothesized formation of reactive radical species, which are responsible for the degradation of the target contaminants.

The term “treatment” refers to as removal of contaminants, including fluorinated compounds and other wastewater contaminants, from an aqueous liquid comprising at least one contaminant by degrading the contaminants with photocatalysts and may also be referred to as “photocatalytic treatment”. The term “treatment cycle” of the photocatalytic treatment may include steps of introducing an aqueous liquid comprising at least one contaminant to a reactor, the reactor containing a photocatalyst, introducing an oxidant to the reactor; activating the photocatalyst by directing light from a light source at the photocatalyst to form an activated photocatalyst; and contacting the oxidant and the at least one contaminant with the activated photocatalyst to react the oxidant and the at least one contaminant, thereby degrading the at least one contaminant.

PFOA degradation is an intense area of study and innovation due, in part, to its recalcitrant characteristics. Experimental data of embodiments of the present disclosure demonstrate that the photocatalyst is effective for the degradation of PFOA in aqueous liquids (e.g., wastewater) using ultraviolet light and oxygen, as illustrated by the following Examples. Experimental data of embodiments of the present disclosure further demonstrate that improve the stability of the BN-based material by coating with a non-semiconductor layer to form the photocatalyst.

In some embodiments, the method for degrading contaminants may further comprise disposing a coating comprising the photocatalyst on a surface of the reactor or on a surface disposed within the reactor.

In some embodiments, the method for degrading contaminants may also comprise forming the photocatalyst, the forming may comprise ball milling the boron nitride and/or hydrothermally exfoliating the boron nitride. Such forming may introduce defects in the photocatalyst intentionally which may contribute to light absorption and photodegradation capability.

In some embodiments, the method for degrading contaminants may further comprise mixing the photocatalyst with a binder which may be an organic binder such as polyethylene glycol or an inorganic binder such as zirconium oxide and silicone oxide.

In some embodiments, the method for degrading contaminants may further comprise affixing the photocatalyst on a nanomaterial to form a photocatalyst containing the nanomaterial and immobilizing the photocatalyst containing the nanomaterial in a membrane. The membrane may comprise polypropylene or polyethersulfone (PES).

In some embodiments, the method for degrading contaminants may further comprise repeating the steps of introducing an aqueous liquid comprising at least one contaminant to a reactor, the reactor containing the photocatalyst, introducing an oxidant to the reactor, activating the photocatalyst by directing light from a light source at the photocatalyst to form an activated photocatalyst, and contacting the oxidant and the at least one contaminant with the activated photocatalyst to react the oxidant and the at least one contaminant, thereby degrading the at least one contaminant. The method for degrading contaminants may be repeated at least one time.

Embodiments disclosed herein may include degrading contaminants in an aqueous liquid with the photocatalyst. The photocatalyst achieves the degradation of contaminants in the presence of an oxidant, under a light source including ultraviolet light such as VUV, UV-A, UV-C, visible light, ambient light, simulated sunlight and natural sunlight. The light source may be monochromatic or polychromatic. The wavelength of the light source may be from artificial light sources including monochromatic light (e.g., 254 nm) or polychromatic light from 160 nm to 700 nm, 200 nm to 650 nm or 250 nm to 600 nm, or from natural sunlight which has a broader range of wavelengths. Activated photocatalyst degrades the contaminants upon activation by the light, converting the contaminants to non-toxic products, thereby decreasing the toxicity of the aqueous liquid.

### Examples

The synthesis of SiO₂-coated BN, for example BN-2, followed the Stöber sol-gel method. 200 mg BN powder was first dispersed in the mixture of 10 mL anhydrous ethanol, 2 mL NH₄OH (5M), and 2.67 mL DI water, followed by vigorously stirring for 30 min to get a uniform mixture. Then, a certain volume of TEOS was added dropwise and the mixture was continuously stirred for 9-12 h at 35° C. The materials were vacuum filtered, thoroughly washed with ethanol and DI water, and then dried to obtain the powder of a target weight loading, ranging from 1 wt % SiO₂ to as high as 10 wt %. The weight loading could possibly be lower, and could be possibly higher.

As an example of a non-semiconductor layer, coating BN with SiO₂ not only makes the photocatalyst more stable in water but increases the photoactivity, leading to a reduced PFOA half-life. Using 25 wt % SiO₂—BN as the reaction system (0.34 g/l initial concentration) gave a PFOA half-life of 11 min, whereas a comparative BN reaction system (0.275 g/L initial concentration) gave a PFOA half-life of 25 min, under conditions of 0.12 mmol/L PFOA, 50 ppm PFOA, 3.5 initial pH, a 24 W, 254 nm ultraviolet (“UV”) lamp, 4.3 mW/cm² spectral irradiance, and air media. This represents at least 100% reduction in half-life, thus at least 100% improvement in activity.

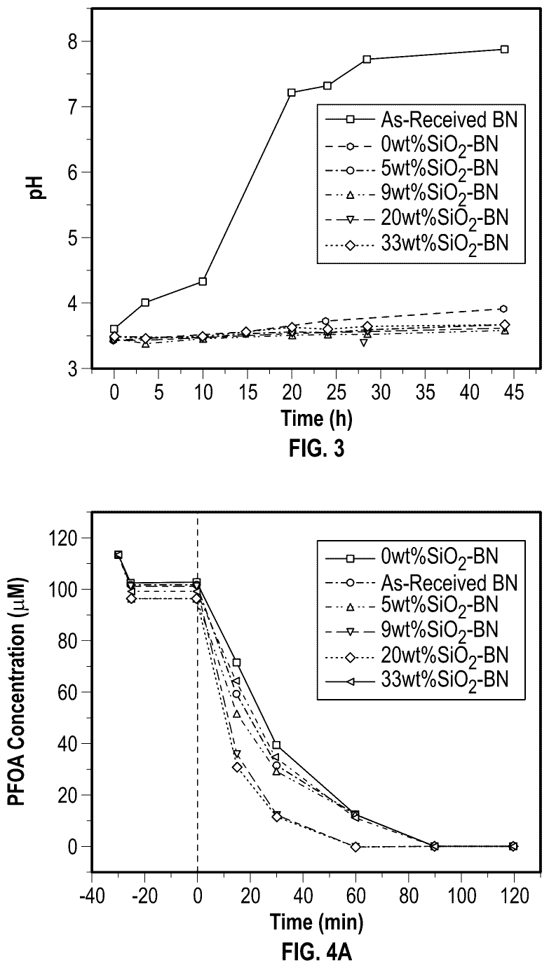

FIG. 3 shows a graphs of pH of the dispersion containing BN-based materials and PFOA, under the conditions: [PFOA]0=˜120 μM (50 ppm), 20 mL DI, 0.27 g/L of BN in various BN-based materials, initial pH 3.5, 29° C., dark. FIG. 1 shows that the pH keeps increasing from 3.5 to ˜8 after 25 h when using the as-receive BN powder, while the increase of pH significantly slows down for 0 wt % SiO2-hBN. It suggests that weakly bonded ammonia exists in the as-received BN powder. However, the pH barely changes after 45 h for the SiO2 coated BN samples, indicating that the coating of SiO2 on the BN surface can slow down the hydrolysis rate of BN in water.

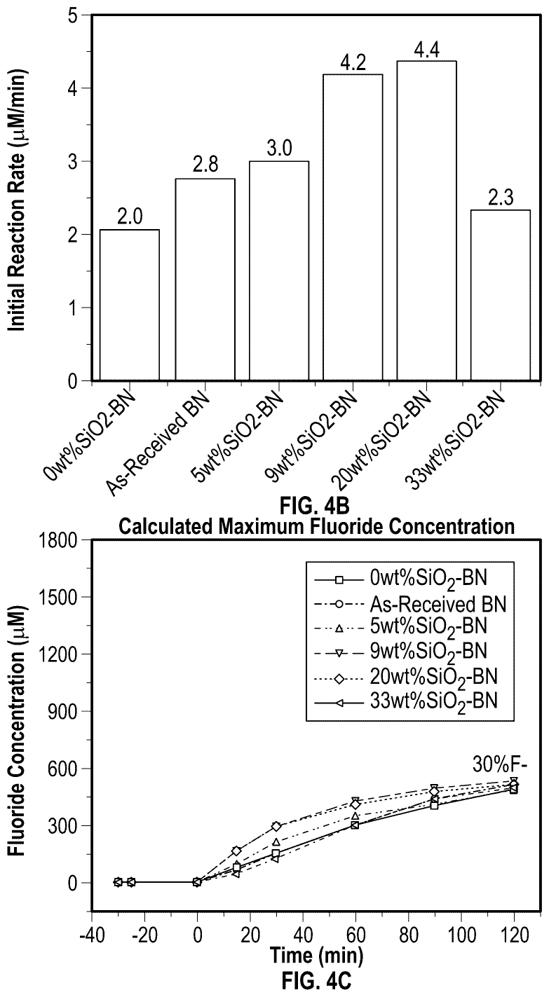

FIGS. 4A, 4B, 4C shows graphs of (a) PFOA concentration-time profiles (b) corresponding calculated initial reaction rates using BN-based materials and (c) Fluoride concentration-time profile, respectively, under reaction conditions: [PFOA] (at t=−30 min)=˜120 μM (50 ppm), 20 mL DI, air headspace, 254-nm light, 0.27 g/L of BN in various BN-based materials, initial pH 3.5, 29° C., photon flux of 6.5×10⁻⁶ Einstein·L⁻¹·s⁻¹.

In FIG. 4A, PFOA concentrations over all the BN-based materials decrease from 120 μM to the undetectable level (˜2.5 μM) within 90 mins under UV-C illumination. The detection of the released fluoride ion in FIG. 4C suggests that decreasing PFOA concentration derives from the photodegradation of PFOA rather than the pure adsorption. All SiO₂ coated BN materials exhibited unexpectedly improved reactivities in comparison with as received BN, except for 0 wt % SiO₂—BN. The relatively slower reactivity might derive from the washing process. The reaction rate increases with the increase of the wt % of SiO₂ on the BN surface until 20 wt %, and then the rate decreases. The decreasing reaction rate might result from too much SiO₂ coating blocking active sites. In FIG. 4B, 20 wt % SiO₂—BN is ˜1.6× more active than as-received BN and the PFOA half-life obtained over the UV-C/20 wt % SiO₂—BN system is ˜ 11 min as shown in FIG. 4A.

The PFOA degradation experiments were done over for received BN, 0 wt % SiO₂—BN, and 20 wt % SiO₂—BN under the same conditions except for elevating the reaction temperature to 49° C.

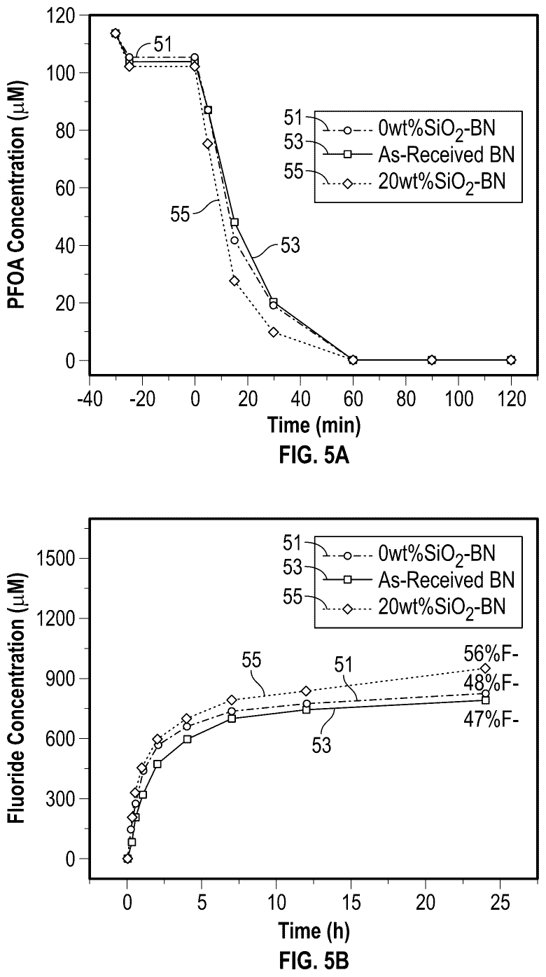

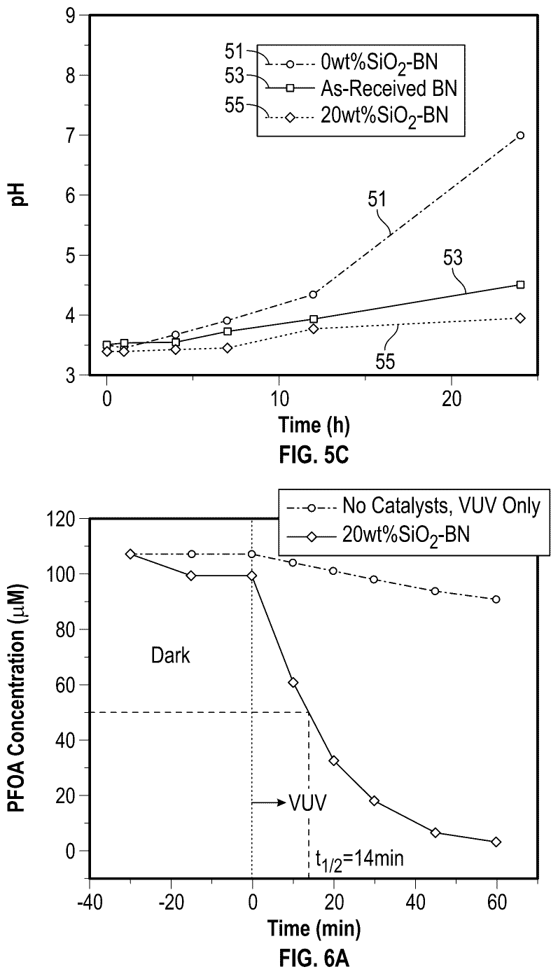

FIGS. 5A, 5B, 5C show graphs of (a) PFOA concentration-time profiles, (b) fluoride ion concentration profiles, and (c) pH profiles using BN-based materials in dark, respectively under reaction conditions: [PFOA] (at t=−30 min)=˜120 μM (50 ppm), 20 mL DI, air headspace, 254-nm light, 0.27 g/L of BN in various BN-based materials, initial pH 3.5, 49° C., photon flux of 6.5×10⁻⁶ Einstein·L⁻¹·s⁻¹. The various BN-based materials are 0 wt. % SiO2-BN 51, As-Received BN 53, and 520 wt. % SiO₂—BN 55.

In comparison of FIG. 5A with FIG. 4A, elevating temperature decreases the amount of pre-adsorbed PFOA on the catalyst surfaces, while accelerating the reaction rates as expected. The initial PFOA degradation rates were 1.4×, 1.8×, and 1.2× faster than those obtained at 29° C. over as received BN, 0 wt % SiO₂—BN, and 20 wt % SiO₂—BN, respectively. 20 wt % SiO₂—BN exhibits the fastest PFOA photodegradation and defluorination (˜56% defluorination after 24 h) rates. Higher temperature also accelerates the hydrolysis rate of BN in water. Increased pH was observed in all three dispersions as shown in FIG. 5C. However, the one containing 20 wt % SiO₂—BN still shows the lowest pH after being stirred in dark after 24 h, suggesting that the SiO₂ coating on the BN surface can slows down hydrolysis of BN thereby imparting higher reactivity and stability. Overall, the SiO₂ coating on BN surface not only slows down the hydrolysis rate of BN and make it more stable in water, but also increases the reactivity towards PFOA photodegradation.

The best SiO₂ coated catalyst, 20 wt % SiO₂—BN, was tested for PFOA degradation under VUV irradiation.

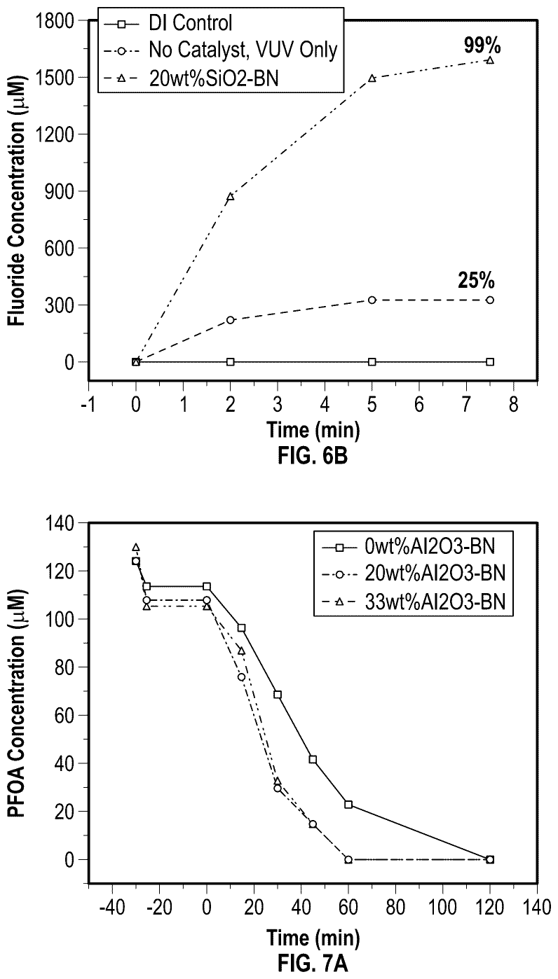

FIGS. 6A, 6B show graphs of (a) PFOA concentration-time profiles, (b) fluoride ion concentration profiles, respectively, under reaction conditions: [PFOA] (at t=−30 min)=˜120 μM (50 ppm), 20 mL DI, air headspace, VUV (185-nm/254-nm light), 0.27 g/L of BN in 20 wt % SiO2-BN, initial pH 3.5, 29° C.

VUV contains 185-nm light, which can directly destroy PFAS, and it can be seen that the PFOA concentration decreases by ˜18% after 1 h of irradiation (photolysis) as shown in FIG. 6A. Under the condition of the VUV/20 wt % SiO₂—BN system, PFOA is destroyed via both photolysis and photocatalysis. PFOA concentration decreases from ˜100 μM to below the detection limit after 60 min VUV irradiation, and a short PFOA half-life of ˜14 min is obtained. The VUV/20 wt % SiO₂—BN system achieves ˜99% defluorination after a 7.5 h reaction, while direct photolysis causes 25% defluorination.

Using the same synthesis method, another non-semiconductor (Al₂O₃) coated BN material with different values of Al₂O₃ weight percent was synthesized and tested them for PFOA degradation under UV-C light.

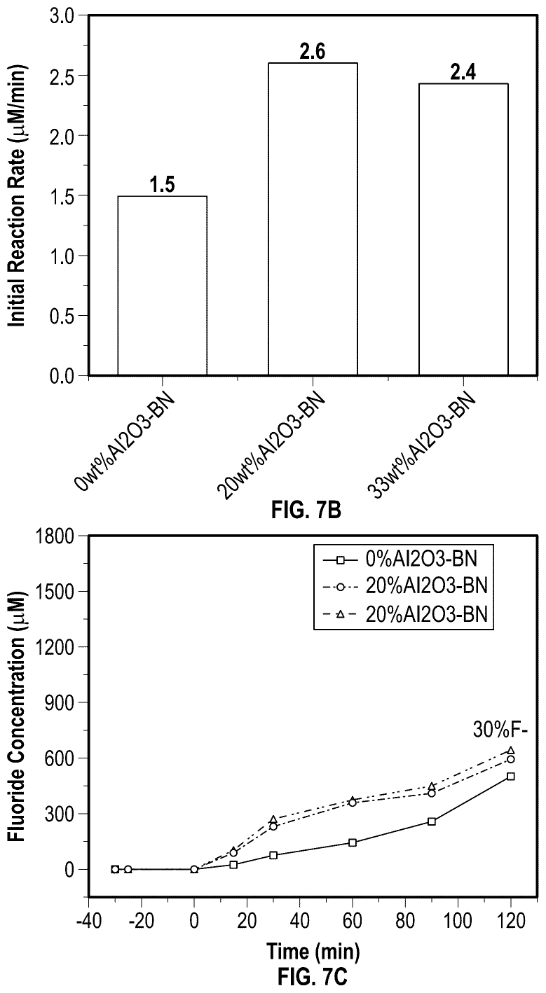

FIGS. 7A, 7B, 7C show graphs of (a) PFOA concentration-time profiles, (b) initial reaction rate profiles, and (c) fluoride ion concentration profiles, respectively, under reaction conditions: [PFOA] (at t=−30 min)=˜120 μM (50 ppm), 20 mL DI, air headspace, 254-nm light, 0.27 g/L of BN in various BN-based materials, initial pH 3.5, 29° C., photon flux of 5.5×10⁻⁶ Einstein·L⁻¹·s⁻¹.

Same with SiO₂ coated BN, all Al₂O₃ coated BN materials exhibited unexpectedly improved reactivities in comparison with uncoated one (0 wt % SiO₂—BN), and the UV-C/20 wt % SiO₂—BN system has the shortest PFOA half-life of ˜ 20 min as shown in FIG. 7A. In FIG. 7B, 20 wt % Al₂O₃—BN shows the fastest reaction rate, which is ˜1.9× more active than the uncoated BN. In FIG. 7C, coated materials exhibit higher defluorination after 2 h reactions.

BN-containing composites with another semiconductor (ZrO₂ and ZnO) were synthesized using the same method. 20 wt % ZrO₂—BN and 20 wt % ZnO—BN are synthesized and tested for PFOA degradation under UV-C irradiation.

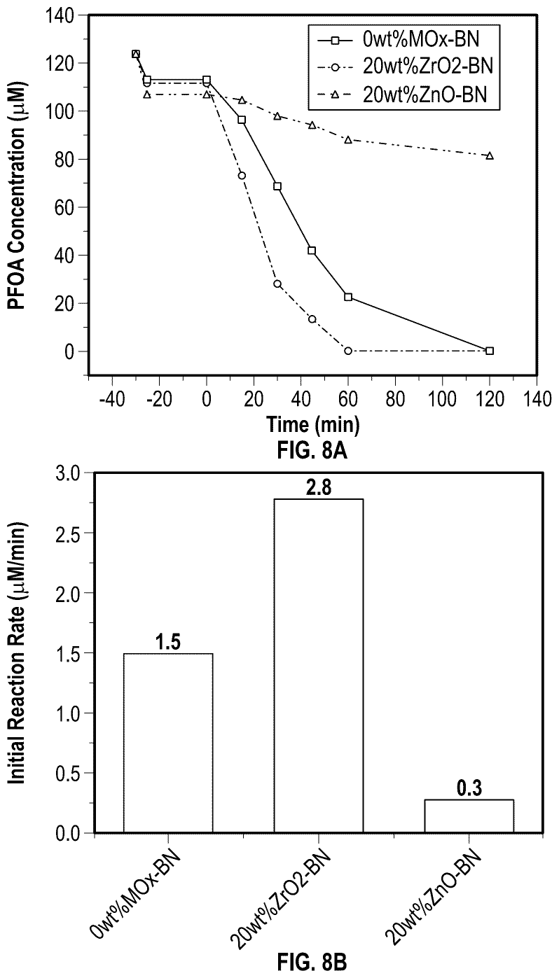

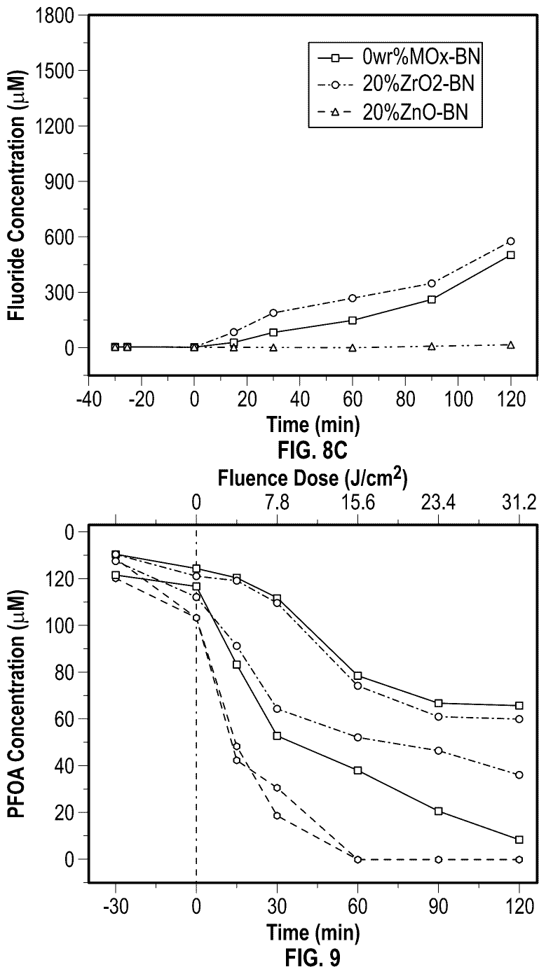

FIGS. 8A, 8B, 8C show graphs of (a) PFOA concentration-time profiles, (b) initial reaction rate profiles, and (c) fluoride ion concentration profiles, respectively, under reaction conditions: [PFOA] (at t=−30 min)=˜120 μM (50 ppm), 20 mL DI, air headspace, 254-nm light, 0.27 g/L of BN in various BN-based materials, initial pH 3.5, 29° C., photon flux of 5.5×10⁻⁶ Einstein·L⁻¹·s⁻¹.

In FIG. 8A, both BN alone and 20 wt % ZrO₂—BN can destroy ˜110 μM PFOA to the undetectable level within 120 min under UV-C illumination, but the composite material exhibits a shorter PFOA half-life (˜21 min). 20 wt % ZnO—BN also works for PFOA degradation under UV-C, but its reactivity is slower than BN alone. The present inventors then calculate the initial reaction rates based on the PFOA concentration profile from 0-15 min. Zr-containing composite exhibits ˜1.9× faster reaction rate than BN alone as shown in FIG. 6B and 36% defluorination in FIG. 6C after 2 h reaction.

FIG. 9 shows a graph of PFOA concentration-time profiles in DI water for BN-1 (filled squares), BN-2 (filled hexagons), and TiO₂ (filled circles) and in 6000 ppm-NaCl water for BN-1 (open squares), BN-2 (open hexagons), and TiO₂ (open circles), using UV heat lamps, illustrating photocatalytic degradation of PFOA. BN-1 was a BN/TiO₂ composite. BN-2 was a specially silica-coated BN material. The reaction conditions included [PFOA]₀˜120 μM, room temperature, air headspace, and initial pH of 3.2. FIG. 9 shows the effect of high salinity water containing 6000 ppm-NaCl under UVC light sources on the performance of TiO₂ and the two BN composites, BN-1 and BN-2.

FIG. 9 illustrates that PFOA had a half-life of 10 min, 25 min, and 45 min for the BN-1, BN-2, and TiO₂ systems using UVC lamp in DI water, respectively. The BN-2 system exhibited the highest initial reaction rate of 3.512 s⁻¹ than 1.347 s⁻¹ of BN-2 and 0.0770 s⁻¹ of TiO₂. After 2 h later, the PFOA conversation (XPFOA) of the BN-1 and BN-2 systems were 100% and 93%, respectively, while TiO₂ was only shown as 68% of XPFOA.

FIG. 9 further illustrates that the performance of BN-2 was unaffected by NaCl, while the performance of TiO₂ or TiO₂ components (BN-1) was significantly inhibited at high salinity. The performance of BN-2 was still the same without decreasing the initial reaction rate (3.432 s⁻¹) and XPFOA (100%) at 6000 ppm NaCl, while TiO₂ and BN-1 systems both significantly decreased more than 10.5 times of initial reaction rate compared to DI water condition.

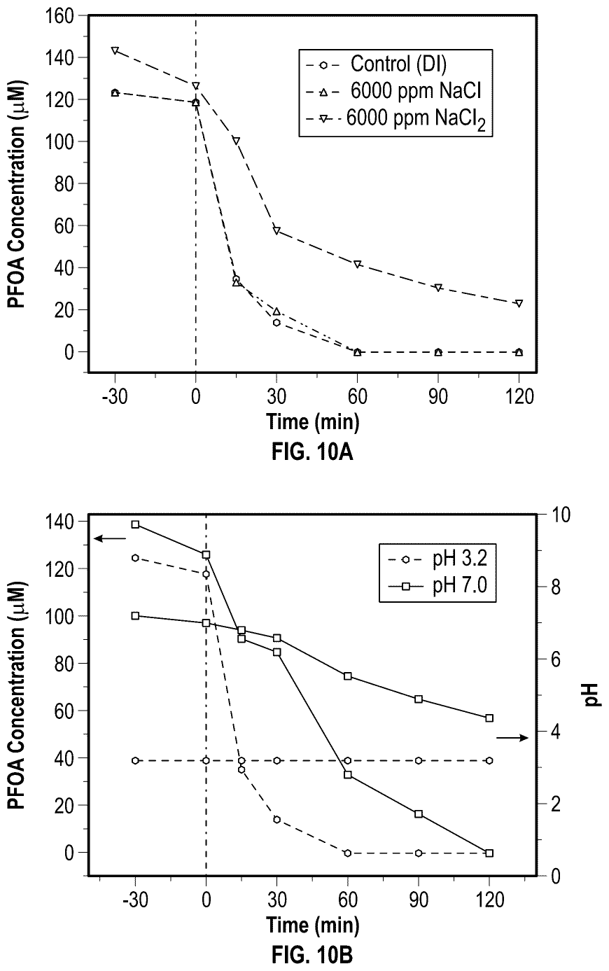

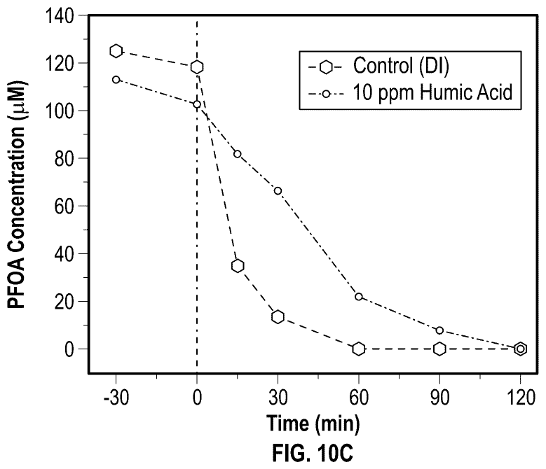

FIGS. 10A, 10B, and 10C show graphs of PFOA concentration-time profiles illustrating effects on photocatalytic degradation of PFOA using a BN-based material under VUV irradiation. The BN-based material was BN-2, the specially silica-coated BN material. The reaction conditions included [PFOA]₀˜120 μM, room temperature, and air headspace. For FIGS. 10A and 10C the reaction conditions included an initial pH of 3.2. FIG. 10B the reaction conditions include one of two different initial pH values, described below.

FIG. 10A shows the effects of common salt co-solutes on the photocatalytic activity of the BN-2 system. FIG. 10A shows PFOA concentration-time profile with a control, illustrated with DI water (hexagons), and 6000 ppm salts, illustrated with NaCl salt (triangles) and CaCl₂) salt (upside down triangles).

FIG. 10B show the effect of pH on the photocatalytic activity of the BN-2 system. FIG. 10B shows PFOA concentration-time profile and pH-time profile for initial pH of 3.2 (hexagons) and 7.0 (squares), using DI water.

FIG. 10C shows the effect of organic matter on the photocatalytic activity of the BN-2 system. FIG. 10C shows PFOA concentration-time profile with a control, illustrated with DI (hexagons), and with 10 ppm organic matter, illustrated with humic acid (circles).

As shown in FIG. 10A, The BN-2 showed a relatively higher adsorption efficacy (−30 min<t<0 min) with PFOA as 11.2% in the presence of CaCl₂) than NaCl and DI water, exhibiting less than 1%. In general, a higher ionic strength (IS) would cause greater electrostatic forces with a decreased double-layer thickness. The higher IS of CaCl₂) (0.162 mol/L) than NaCl (0.102 mol/L) can increase the stronger attractive electrical double layer forces between the positively charged BN-2 and PFOA, which predominantly dissociates to a slightly negatively charged form at acid condition (pKa of PFOA=2.8).

The initial reaction rate of 0.512 s⁻¹ in BN-system under DI water was decreased in the presence of 6000 ppm CaCl₂), as shown in FIG. 10A, and 10 ppm humic acid, as shown in FIG. 10C, as 0.963 s⁻¹ and 0.911 s⁻¹, respectively, while the degradation of PFOA was less inhibited by neutral pH with 1.337 s⁻¹ of initial reaction rate, as shown in FIG. 10B. The inhibiting effect of Ca²⁺ and humic acid on the degradation of PFOA may be due to the competitive trapping of the hole and reactive oxidizing species such as ·OH and ·O2⁻. In addition, the divalent cations of Ca²⁺ can also form a bridge between negatively charged carboxyl groups in PFAS or other functional groups in humic acid. Therefore, the present inventors concluded that competitive adsorption and poorer UV light penetration by the Ca²⁺ binding products may be associated with lower photocatalytic performance.

The performance of photocatalytic reactions can be affected by environmental factors such as dissolved organic matter (DOM), soluble inorganic compounds, colloidal or particulate matter, microorganisms, pH, and temperature in the feed solutions. Among them, soluble inorganic compounds and DOM, which are major concerns for the influent of advanced water treatment processes (WTPs), since most of the colloidal or particulate matters, and microorganisms are previously removed by conventional WTPs such as coagulation and flocculation/sedimentations, microfiltration membrane or sand filtration.

The data shown in FIGS. 10A, 10B, and 10C illustrate that the BN-2 will be effective in photocatalytically degrading PFAS in real waters that contain high salt concentrations and other constituents, opening up their usefulness to a wider range of water types.

Embodiments of the present disclosure may provide at least one of the following advantages.

Photocatalytic destruction of contaminants in water is preferable to methods based on physical separations (e.g. carbon filtration, reverse osmosis, ion exchange), as it directly destroys and renders the compound non-toxic, while separation methods generate waste streams and/or require regenerative treatments to destroy the compounds.

The present disclosure expands the number of semiconductor materials which BN can be combined with for improved photoactivity. In addition, the presence of oxygen-containing surface defects makes BN hydrolyzes in water over time, leading to an increasing pH (BN reacts with water to produce ammonia). The present disclosure introduces coated BN-based materials, which are more stable in water and have been shown more effective for the removal of persistent compounds in comparison with commercial BN powder. Surface defects enable commercial BN to absorb UV-C light. However, BN has an intensified absorbance at the wavelength of ˜208 nm according to DR-UV characterization, thus coated BN might exhibit better reactivity under V-UV (185 nm) light illumination. Some coated BN-based materials containing another semiconductor might extend the spectral absorbance and achieve photodegradation of the persistent compounds under energy-efficient conditions, while commercial BN powder cannot. The possible reaction pathways contain the reaction of the persistent compounds with presumed reactive oxidation species generated during the photocatalytic reaction. Because of the activity of these species, they can be used to destroy other less-stable organic compounds, such as 1,4-dioxane, pharmaceuticals, pesticides, or chlorinated solvents in water, the degradation of which can be enhanced with the variations described herein. In addition, the use of UV light enables the direct UV disinfection of contaminated water.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke means-plus-function for any limitations of any of the claims herein, except for those in which the claim expressly uses the words ‘means for’ together with an associated function.

1. A photocatalyst, comprising:
a photocatalytic core comprising boron nitride; and
a layer coated on the photocatalytic core and comprising a non-semiconductor material;
wherein the photocatalyst is catalytically active for degrading one or more contaminants under conditions of irradiation by light; and
wherein the layer improves one or more properties of the photocatalyst as compared to the photocatalytic core in the absence of the layer.

2. The photocatalyst of claim 1, wherein the light ranges from 160-700 nm in wavelength.

3. The photocatalyst of claim 1, wherein the photocatalytic core comprises a material selected from the group consisting of hexagonal boron nitride, boron nitride nanotube, boron nitride composite with a semiconductor material, and combinations thereof.

4. The photocatalyst of claim 1, wherein the photocatalytic core further comprises a semiconductor material.

5. The photocatalyst of claim 4, wherein the semiconductor material has a smaller band gap than the boron nitride.

6. The photocatalyst of claim 4, wherein the semiconductor material is activated with light ranging from 160-700 nm in wavelength.

7. The photocatalyst of claim 4, wherein the semiconductor material is selected from the group consisting of metal oxides, carbides, nitrides, and combinations thereof.

8. The photocatalyst of claim 7, wherein the semiconductor material is selected from the group consisting of TiO₂, ZrO₂, ZnO, SiC, CₓN_{y}, and combinations thereof.

9. (canceled)

10. (canceled)

11. (canceled)

12. The photocatalyst of claim 1, wherein the non-semiconductor material is selected from the group consisting of SiO₂, Al₂O₃, and combinations thereof.

13. The photocatalyst of claim 1 further comprising a functionalization material supported by the layer.

14. The photocatalyst of claim 13, wherein the functionalization material is selected from the group consisting of metal nanoparticles and metal oxide nanodomains.

15. The photocatalyst of claim 14, wherein the metal nanoparticles comprise a metal selected from the group consisting of Ag, Au, Pd, Pt, Ir, Rh, Ru, and combinations thereof.

16. The photocatalyst of claim 14, wherein the metal oxide nanodomains comprise a metal oxide selected from the group consisting of Al_{y}Oₓ, WOₓ, and combinations thereof.

17. (canceled)

18. (canceled)

19. The photocatalyst of claim 1, wherein the photocatalyst is catalytically active to degrade the one or more contaminants with 100% reduced half-life as compared to the photocatalytic core in the absence of the layer.

20. The photocatalyst of claim 1, wherein the one or more contaminants comprise one or more fluorinated compounds.

21. The photocatalyst of claim 20, wherein the one or more fluorinated compounds comprise one or more perfluorocarboxylic acids.

22. (canceled)

23. (canceled)

24. A membrane for use in a water purification system, the membrane comprising a polymer and the photocatalyst of claim 1 contained within the polymer.

25. A system for degrading one or more contaminants, including fluorinated compounds and other wastewater contaminants, comprising:
a reactor for receiving an aqueous liquid comprising at least one contaminant, and containing the photocatalyst according to claim 1;
a light source for directing the irradiating light to the photocatalyst; and
an oxidant source in fluid communication with the reactor.

26. A method for degrading contaminants, comprising:
introducing an aqueous liquid comprising at least one contaminant to a reactor, the reactor containing the photocatalyst according to claim 1;
introducing an oxidant source to the reactor;
activating the photocatalyst by directing the irradiating light from a light source to the photocatalyst to form an activated photocatalyst; and
contacting the oxidant and the at least one contaminant with the activated photocatalyst to react the oxidant and the at least one contaminant, thereby degrading the at least one contaminant.
